(19) United States
(12) Patent Application Publication
(10) Pub. No.: US 2007/0133449 A1
(43) Pub. Date: Jun. 14, 2007

(54) Method for associating multiple users with a shared downlink channel

(76) Inventors: Mirko Schacht, Nurnberg (DE); Peter Hans Schefczik, Erlangen (DE); Rainer Bachl, Nuremberg (DE)

Correspondence Address: WILLIAMS, MORGAN & AMERSON, 10333 RICHMOND, SUITE 1100, HOUSTON, TX, 77042, US

(21) Appl. No.: 11/301,271

(22) Filed: Dec. 12, 2005

(51) Int. Cl. H04H 1/00

(52) U.S. Cl. 370/312

(57) ABSTRACT

The present invention provides a method for associating multiple users with a shared downlink channel. One embodiment of the method may include associating an identifier with a plurality of mobile units and providing at least one multicast service to the plurality of mobile units over a shared channel using the identifier. Another embodiment of the method may include receiving at least one multicast service over a shared channel using an identifier associated with a plurality of mobile units.

### BACKGROUND OF THE INVENTION

1. Field of the Invention

This invention relates generally to communications systems, and, more particularly, to wireless communication systems.

2. Description of the Related Art

Conventional wireless communication systems include one or more base stations or base station routers, which may also be referred to as access points or node-Bs or access networks, for providing wireless connectivity to one or more mobile units, which may also be referred to using terms such as user equipment, subscriber equipment, and access terminals. Exemplary mobile units include cellular telephones, personal data assistants, smart phones, text messaging devices, laptop/notebook computers, desktop computers, and the like. Each base station may provide wireless connectivity to one or more mobile units, such as the mobile units in a geographical area, or cell, associated with the base station. For example, a base station may provide wireless connectivity to mobile units located in a cell according to a Universal Mobile Telecommunication System (UMTS) specification. Alternatively, a base station router may be used to provide wireless connectivity to the mobile units.

Wireless communication systems may provide multicast services to the mobile units in the system. In a multicast transmission, information in the form of packets is provided by a source, such as a multicast server coupled to the wireless communication system, and the packets are replicated so that identical information may be transmitted concurrently to multiple users. Thus, a single server may provide multicast services concurrently to many mobile units. For example, a single multicast server may provide video streaming, interactive game delivery, news clips, and the like concurrently to several mobile units. Users of mobile units typically subscribe to the multicast services and the mobile units then monitor one or more signaling channels to determine when a multicast transmission may occur. When the mobile unit determines that a multicast transmission is available, the mobile unit may establish a communication channel to receive the multicast transmission.

Conventional multicast service providers deliver information to the mobile units over the air interface using dedicated channels (DCHs) associated with each mobile unit. For example, if several mobile units subscribe to a multicast service provided via a base station, then a dedicated channel is established for each mobile unit and the dedicated channels are used to transmit the multicast packets from the base station to the associated mobile units. However, implementing a multicast service using dedicated channels has a number of drawbacks. For example, each mobile unit consumes resources associated with establishing and/or maintaining the dedicated channel. If a new mobile unit begins transmitting, the corresponding rise in the interference level may force the other mobile units to increase their transmission powers and consume additional resources. Thus, resource utilization scales exponentially with the number of mobile units. Consequently, the total number of mobile units that may receive a multicast service is typically limited by the radio resources available to the multicast service. The restrictions on the number of mobile units that may receive a multicast service may translate into a restriction on the number of potential subscribers, which may in turn limit the potential revenue that may be generated by providing multicast services.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for associating multiple users with a shared downlink channel. One embodiment of the method may include associating an identifier with a plurality of mobile units and providing at least one multicast service to the plurality of mobile units over a shared channel using the identifier. Another embodiment of the method may include receiving at least one multicast service over a shared channel using an identifier associated with a plurality of mobile units.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates a first exemplary embodiment of a communication system, in accordance with the present invention;

FIG. 2 conceptually illustrates a second exemplary embodiment of a communication system, in accordance with the present invention; and

FIG. 3 conceptually illustrates one exemplary embodiment of a method for providing multicast services to a plurality of mobile users, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art.

The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

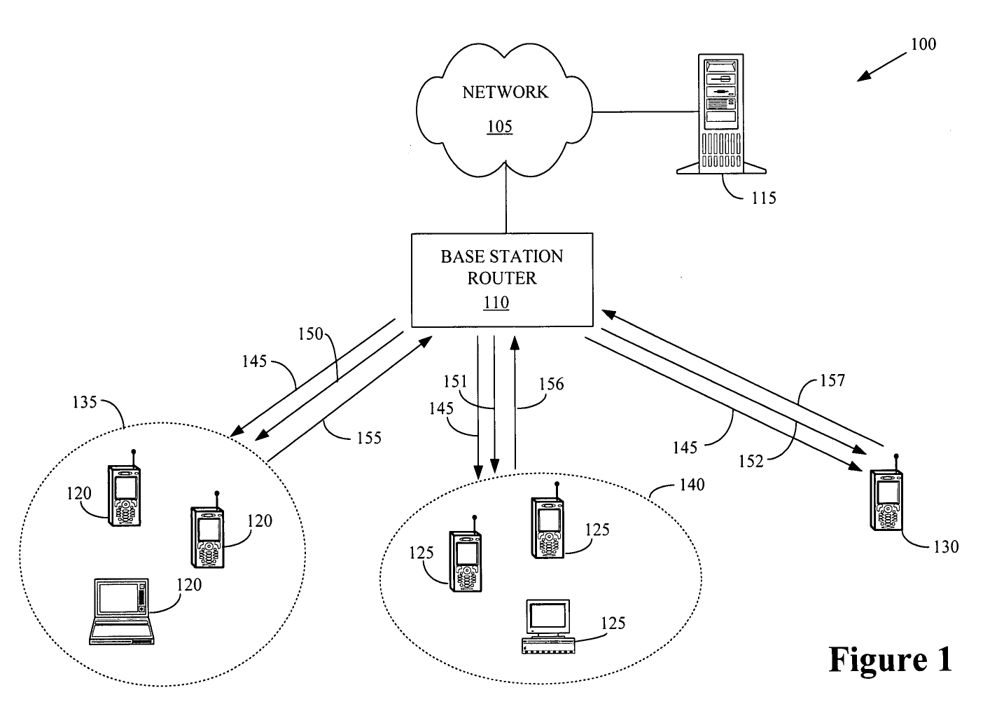

FIG. 1 conceptually illustrates a first exemplary embodiment of a communication system 100. In the illustrated embodiment, the communication system 100 includes a network 105 that is communicatively coupled to a base station router 110. Alternatively, a base station (not shown) may be coupled to the network 105. Accordingly, at least a portion of the network 105 may operate according to wireless communication protocols such as specified in the Third Generation Partnership Project (3GPP) standardization of the Universal Mobile Telecommunication Services (UMTS) wireless communication system. For example, the network 105 may operate according to Release 6 of the 3GPP UMTS wireless communication system. However, persons of ordinary skill in the art having benefit of the present disclosure should appreciate that the present invention is not limited to the network 105 that operates only according to a 3GPP UMTS protocol. In alternative embodiments, portions of the network 105 may operate according to any wireless application protocol, such as a Code Division Multiple Access (CDMA, CDMA2000) protocol, a Bluetooth protocol, one of the IEEE 802 protocols, and the like. Moreover, portions of the network 105 may operate according to one or more wired communication protocols, such as a Public Switched Telephone Network (PSTN), a Plain Old Telephone System (POTS), and the like.

The network 105 is configured to provide multicast services. As used herein, the term “multicast service” refers to services that may be provided by a single server concurrently to a plurality of users. For example, packets associated with a multicast service may be replicated within the network 105 so that the multicast service may be provided concurrently to a plurality of users. A multicast service may also be referred to as a “point-to-multipoint” service. However, persons of ordinary skill in the art having benefit of the present disclosure should appreciate that a multicast service may include more than one source of packets, in which case the service may be referred to as a “multipoint-to-multipoint” service. Exemplary multicast services may include video streaming, interactive game delivery, news broadcasts, and the like. In embodiments of the network 105 that implement Release 6 of the 3GPP UMTS, multicast services may be provided using the Multicast Broadcast Multimedia Services (MBMS) feature defined by this service. However, persons of ordinary skill in the art having benefit of the present disclosure should appreciate that other multicast features, which may be defined by other protocols, may be used.

The illustrated embodiment of the communication system 100 includes a multicast server 115 that is configured to provide multicast services to mobile units 120, 125, 130 via the network 105 and the base station router 110. However, persons of ordinary skill in the art having benefit of the present disclosure should appreciate that the wireless communication system 100 is not limited to a single multicast server 115. In alternative embodiments, any number of multicast servers 115 may be communicatively coupled to the network 105. The mobile units 120, 125, 130 are assumed to have subscribed to one or more of the multicast services provided by the multicast server 115. For example, the mobile units 120, 125, 130 may be subscribed to one or more multicast services when they are purchased or a user of the mobile units 120, 125, 130 may subscribe to one or more multicast services at a later time. Techniques for subscribing to the multicast services are known to persons of ordinary skill in the art and, in the interest of clarity, will not be described further herein.

Identifiers may be associated with the mobile units 120, 125, 130. For example, High Speed Downlink Shared Channel (HS-DSCH) Radio Network Identifiers (HRNTIs) may be assigned to the mobile units 120, 125, 130. In one embodiment, the identifiers may be associated with the mobile units 120, 125, 130 when the mobile units 120 125, 130 subscribe to one or more multicast services. The mobile units 120, 125 may be associated with groups 135, 140, respectively, and a single identifier is associated with each of the mobile units 120, 125 in each of the groups 135, 140. For example, the mobile units 120 in the group 135 may be subscribed to a first service and may be associated with a first HRNTI and the mobile units 125 in the group 140 may also be subscribed to the first service and may be associated with a second HRNTI that differs from the first HRNTI. However, persons of ordinary skill in the art should appreciate that not all of the mobile units 120, 125, 130 need to be associated with one or more of the groups 135, 140. For example, the mobile unit 130 may be subscribed to the first service but may not be associated with any group. Accordingly, the mobile unit 130 may be associated with its own identifier, such as a third HRNTI. In one embodiment, the identifiers may be provided to the mobile units 120, 125, 130 using L3 signaling.

In operation, the mobile units 120, 125, 130 monitor a signaling channel 145 provided by the base station router 110 to determine whether or not a multicast service is being provided. Although the signaling channel 145 is indicated by three arrows in FIG. 1, persons of ordinary skill in the art having benefit of the present disclosure should appreciate that the signaling channel 145 is a single channel being broadcast by the base station router 110 that may be monitored by any device proximate the base station router 110. In one embodiment, the signaling channel 145 is a High Speed Shared Control Channel (HSSCCH), which may broadcast control information associated with the multicast services. However, persons of ordinary skill in the art should appreciate that the base station router 110 may support more than one signaling channel 145 and the mobile units 120, 125, 130 may monitor one or more signaling channels 145. For example, the base station router 110 may support four or more signaling channels 145 and the mobile units 120, 125, 130 may monitor up to four signaling channels 145.

When a multicast transmission is scheduled by the multicast server 115, the mobile units 120, 125, 130 may be notified by broadcasting control information over the signaling channel 145. The control information may include an indication that new data is available, a retransmission request process identifier (such as a HARQ process ID), and a Transport Format and Resource Indicator (TFRI). The TRFI may include information associated with the transmission including a transport format for a downlink channel that may indicate a transport block set size, a modulation scheme, one more channelization codes associated with the downlink channel, and the like. Information transmitted over the signaling channel 145 may be masked using the identifiers associated with the mobile units 120, 125, 130. Accordingly, the mobile units 120, 125 in the groups 135, 140 may be notified of scheduled multicast transmissions using a single identifier, such as an HRNTI, to mask the information transmitted over the signaling channel 145.

The multicast server 115, the network 105, and/or the base station router 110 may provide the scheduled multicast services to the mobile units 120, 125, 130 over shared channels 150, 151, 152. For example, the shared channels 150, 151, 152 may be time multiplexed channels. In the illustrated embodiment, the shared channel 150 is associated with the group 135, the shared channel 151 is associated with the group 140, and the shared channel 152 is associated with the mobile unit 130. Persons of ordinary skill in the art should also appreciate that the present invention is not limited to three shared channels 150, 151, 152. In alternative embodiments, the base station router 110 may be capable of providing multicast services over more or less than three shared channels 150, 151, 152.

The shared channels 150, 151, 152 may be used to provide multicast services to the mobile units 120, 125, 130, respectively. For example, the shared channel 150 may be used to provide multicast services to the mobile units 120 in the group 135 by transmitting information associated with the multicast service in one or more transmission time intervals (TTI) of a time multiplexed physical channel. For another example, the shared channel 151 may be used to provide multicast services to the mobile units 125 by transmitting information associated with the multicast service in other transmission time intervals (TTI) of the time multiplexed physical channel. For yet another example, the shared channel 152 may be used to provide multicast services to the mobile unit 130 by transmitting information associated with the multicast service in yet other transmission time intervals (TTI) of the time multiplexed physical channel. Accordingly, the multicast services may be provided to pluralities of mobile units 120, 125, 130 using a reduced number of downlink channels relative to techniques that allocate a dedicated channel to each mobile unit 120, 125, 130.

The mobile units 120, 125, 130 may also provide feedback information over one or more uplink channels 155, 156, 157. In one embodiment, each of the mobile units 120, 125, 130 provides channel quality information over a High Speed Downlink Physical Control Channel (HS-DPCCH). For example, each of the mobile units 120, 125, 130 may provide channel quality information over an HS-DPCCH associated with the mobile unit 120, 125, 130 using a Channel Quality Indicator (CQI). Accordingly, persons of ordinary skill in the art having benefit of the present disclosure should appreciate that the arrows 155, 156 may be representative of a plurality of uplink channels associated with the pluralities of mobile units 120, 125. For example, the arrow 155 may be representative of three HS-DPCCHs associated with the three mobile units 120.

The network 105 may use the channel quality information provided by the mobile units 120, 125, 130 to allocate the radio resources associated with the multicast services. In one embodiment, the network 105 may use the channel quality information to optimize a transport format for transmissions associated with the multicast services over the shared channels 150, 151, 152. For example, the network 105 may use the channel quality information provided by the mobile units 120 to select a coding/modulation scheme and/or a transport block size to be used for packets transmitted over the shared channel 150. In one embodiment, the network 105 may allocate the radio resources based upon the lowest channel quality associated with one of the mobile units 120, 125, 130 in each of the groups 135, 140.

In one embodiment, the mobile units 120, 125, 130 may be associated with one or more of the groups 135, 140 based upon a data transmission rate and/or a channel quality associated with the mobile units 120, 125, 130. For example, the mobile units 120 may be subscribed to a multicast service and may be associated with the group 135 because the mobile units 120 have reported a relatively high channel quality and therefore may be associated with a relatively high data transmission rate for the multicast service, such as 16 Quadrature Amplitude Modulation (16QAM). For another example, the mobile units 125 may be associated with the group 140 because the mobile units 125 are subscribed to the multicast service and have reported a channel quality that is sufficient to support High Speed Downlink Packet Access (HSDPA) but not sufficiently high to permit the use of 16QAM modulation for the multicast service. In one embodiment, mobile units 120, 125, 130 that report relatively poor channel conditions and consequently can only be supported by low rate HSDPA or the multicast service may be allocated a dedicated channel, such as a legacy DCH. For example, the mobile unit 130 may be located near an edge of the cell associated with the base station router 110 and may therefore be assigned a legacy DCH for receiving multicast services. Handoff of the mobile unit 130 to a neighboring cell may be facilitated by assigning a legacy DCH to the mobile unit 130, as will be discussed in detail below.

The mobile units 120, 125, 130 may provide acknowledgment feedback, e.g., using the uplink channels 155, 156, 157. In one embodiment, the acknowledgment feedback may include a positive acknowledgment (ACK) and/or negative acknowledgment (NACK) messages. When the base station router 110 receives a NACK message, one or more packets associated with the NACK message may be retransmitted to one or more of the mobile units 120, 125, 130. In one embodiment, a feedback power associated with the acknowledgment messages may be adjusted so that the base station router 110 may receive the NACK messages, but not the ACK messages. For example, the transmission power for ACK messages may be set relatively low and the transmission power for NACK messages may be set relatively high. However, persons of ordinary skill in the art should appreciate that providing acknowledgment feedback is an optional feature and may not be included in all embodiments of the communication system 100. Furthermore, other techniques for providing the acknowledgment messages may be used.

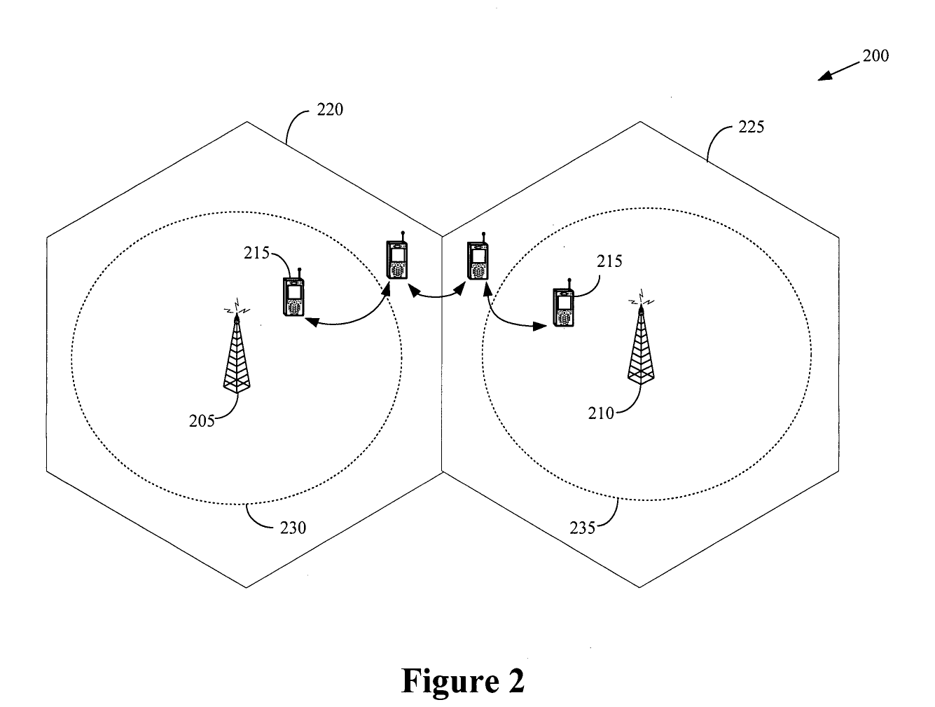

FIG. 2 conceptually illustrates a second exemplary embodiment of a communication system 200. In the illustrated embodiment, the communication system 200 includes two base station routers 205, 210 that may be used to provide wireless connectivity to a mobile unit 215 within geographic areas or cells 220, 225. However, persons of ordinary skill in the art should appreciate that the present invention is not limited to two base station routers 205, 210 providing wireless connectivity to two cells 220, 225. In alternative embodiments, the wireless communication system 200 may include any number of base station routers 205, 210 that may provide wireless connectivity to any number of cells 220, 225. In the illustrated embodiment, the wireless communication system 200 is configured to provide one or more multicast services via the base station routers 205, 210.

Initially, the mobile unit 215 is located in an area proximate the base station router 205 (as indicated by the dashed circle 230) where the mobile unit 215 is capable of receiving multicast service transmissions at a relatively high channel quality and/or a relatively high data rate. However, persons of ordinary skill in the art having benefit of the present disclosure should appreciate that the channel quality and/or data rate may not be determined solely by proximity to the base station router 205. For example, buildings, geographical features, and/or other obstructions may also affect the channel quality and/or the data rate available to the mobile unit 215. Thus, the area 230 may not be well represented by a circle and instead may include various irregularities. The mobile units 215 may be associated with a group of mobile units (not shown) that all share a relatively high channel quality and/or a relatively high data rate and therefore receive multicast service transmissions over a single shared channel, as described above.

The mobile unit 215 may then move outside of the region 230 and into an area proximate an edge of the cell 220 where the channel quality and/or the data rate may decrease. The mobile unit 215 may therefore be removed from the group of mobile units having relatively high channel quality and/or data rate and may instead be associated with a dedicated channel, such as a legacy DCH. The wireless communication system 200 may then provide the multicast service transmissions over the dedicated legacy DCH. If the mobile unit 215 then leaves the cell 220 and roams into the cell 225, the mobile unit 215 may be handed off from the dedicated legacy DCH associated with the base station router 205 to a dedicated legacy DCH provided by the base station router 210. Techniques for handing off the mobile unit 215 from the base station router 205 to the base station router 210 are known to persons of ordinary skill in the art and, in the interest of clarity, will not be discussed further herein.

Following the handoff from the base station router 205 to the base station router 210, the mobile unit 215 may be outside of a region 235 where the mobile unit 215 is capable of receiving multicast service transmissions via the base station router 210 at a relatively high channel quality and/or a relatively high data rate. The mobile unit 215 may therefore be associated with the dedicated channel, such as the legacy DCH described above. However, the mobile unit 215 may continue to roam into the region 235 where the mobile unit 215 is capable of receiving multicast service transmissions via the base station router 210 at a relatively high channel quality and/or relatively high data rate. Accordingly, the mobile unit 215 may be associated with a group (not shown) of mobile units that are also capable of receiving multicast service transmissions at the relatively high channel quality and/or relatively high data rate.

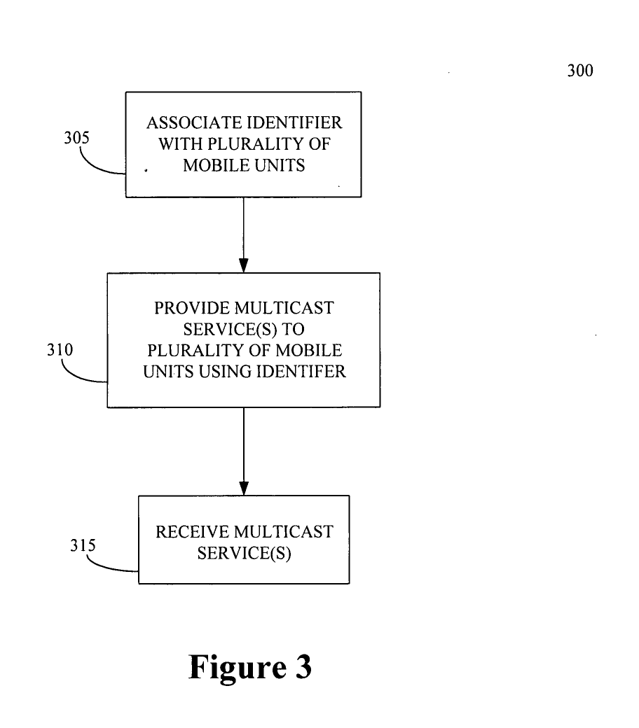

FIG. 3 conceptually illustrates one exemplary embodiment of a method 300 for providing multicast services to a plurality of mobile users. In the exemplary embodiment, an identifier is associated (at 305) with a plurality of mobile units. For example, an HRNTI may be associated with a plurality of mobile units having similar channel qualities and/or data rates. Multicast services may then be provided (at 310) to the plurality of mobile units associated with the identifier. For example, the mobile units may be notified of a scheduled multicast service transmission over a signaling channel using information indicative of the identifier as a mask. The notification may include information indicating a shared channel that will be used to transmit packets associated with the multicast service, as well as various control parameters associated with the shared channel. The mobile units may then receive (at 315) one or more multicast services over the shared channel.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
associating an identifier with a plurality of mobile units; and
providing at least one multicast service to the plurality of mobile units over a shared channel using the identifier.

2. The method of claim 1, wherein associating the identifier with the plurality of mobile units comprises associating a radio network identifier with the plurality of mobile units.

3. The method of claim 1, wherein associating the identifier with the plurality of mobile units comprises associating the identifier with the plurality of mobile units based on at least one of a data rate associated with at least one of the plurality of mobile units and at least one channel quality associated with at least one of the plurality of mobile units.

4. The method of claim 1, comprising associating a plurality of identifiers with corresponding pluralities of mobile units.

5. The method of claim 1, comprising dedicating a channel to one of the plurality of mobile units.

6. The method of claim 5, wherein dedicating a channel to one of the plurality of mobile units comprises dedicating the channel to one of the plurality of mobile units based on at least one of a data rate associated with said one of the plurality of mobile units and a channel quality associated with said one of the plurality of mobile units.

7. The method of claim 5, comprising handing off the mobile unit associated with the dedicated channel to another dedicated channel.

8. The method of claim 1, wherein providing at least one multicast service to the plurality of mobile units over the shared channel using the identifier comprises providing signaling information associated with said at least one multicast service to the plurality of mobile units over a signaling channel using the identifier as a mask.

9. The method of claim 8, wherein providing the signaling information comprises providing information indicative of at least one of new data, a retransmission request identifier, a transport format, a transport block set size, a modulation scheme, a physical channel, and a channelization code.

10. The method of claim 1, wherein providing said at least one multicast service comprises determining a transport format.

11. The method of claim 10, wherein determining the transport format comprises determining at least one of a coding scheme, a modulation scheme, and a transport block size.

12. The method of claim 10, comprising receiving information indicative of at least one channel quality associated with at least one of the plurality of mobile units.

13. The method of claim 12, wherein determining the transport format comprises determining a transport format based on the information indicative of at least one channel quality associated with at least one of the plurality of mobile units.

14. The method of claim 13, wherein determining the transport format comprises determining the transport format based on a lowest channel quality associated with at least one of the plurality of mobile units.

15. The method of claim 1, wherein providing said at least one multicast service comprises receiving at least one of an acknowledgment and a negative acknowledgment from at least one of the plurality of mobile units.

16. The method of claim 15, comprising retransmitting at least one packet in response to receiving at least one negative acknowledgment from at least one of the plurality of mobile units.

17. A method, comprising:
receiving at least one multicast service over a shared channel associated using an identifier associated with a plurality of mobile units.

18. The method of claim 17, wherein receiving said at least one multicast service comprises receiving at least one multicast service over a shared channel using a radio network identifier with the plurality of mobile units.

19. The method of claim 17, wherein receiving said at least one multicast service comprises receiving at least one multicast service over a shared channel using the identifier associated with the plurality of mobile units based on at least one of a data rate associated with at least one of the plurality of mobile units and at least one channel quality associated with at least one of the plurality of mobile units.

20. The method of claim 17, wherein receiving said at least one multicast service comprises handing off from the dedicated channel to another dedicated channel.

21. The method of claim 17, wherein receiving at least one multicast service comprises receiving signaling information associated with said at least one multicast service over a signaling channel using the identifier as a mask.

22. The method of claim 21, wherein receiving the signaling information comprises receiving information indicative of at least one of new data, a retransmission request identifier, a transport format, a transport block set size, a modulation scheme, a physical channel, and a channelization code.

23. The method of claim 22, comprising providing information indicative of at least one channel quality.

24. The method of claim 17, comprising providing a positive acknowledgment or a negative acknowledgment.

25. The method of claim 24, comprising receiving at least one retransmitted packet in response to providing at least one negative acknowledgment.
